(19) United States
(12) Patent Application Publication
(10) Pub. No.: US 2006/0263556 A1
(43) Pub. Date: Nov. 23, 2006

(54) Elastomer compositions for use in a hydrocarbon resistant hose

(75) Inventor: Harold D. Beck, Strafford, MO (US)

Correspondence Address: DAYCO PRODUCTS, LLC, 1 PRESTIGE PLACE, MIAMISBURG, OH, 45342, US

(73) Assignee: Dayco Products, LLC

(21) Appl. No.: 11/493,723

(22) Filed: Jul. 26, 2006

Related U.S. Application Data
(63) Continuation-in-part of application No. 10/799,865, filed on Mar. 11, 2004.
Application No. 10/799,865 is a continuation-in-part of application No. 10/663,324, filed on Sep. 15, 2003.

(51) Int. Cl. B29C 47/00

(52) U.S. Cl. 428/36.9; 524/564

(57) ABSTRACT

A vinyl ester composition; a tubular structure such as a hose for conveying fluids in an automotive engine cooler, transmission oil cooler, power transmission cooler, radiator or heater; and a method for preparing the tubular structure are described. The tubular structure includes a single layer of a heat tolerant, pressure resistant, hydrocarbon fluid impermeable composition comprising a copolymer of a first vinyl ester and a second vinyl ester, and one or more additives. The composition may, optionally contain a second polymeric component such as an ethylene-vinyl ester of a C₂ to C₆ carboxylic acid, chlorinated polyolefins, chlorosulfonated polyolefins, polychloroprene, ethylene-acrylic rubber, alkyl acrylate copolymer, polyvinyl acetate, acrylonitrile-butadiene rubber, hydrogenated acrylonitrile-butadiene rubber, ethylene-propylene-diene terpolymer, styrene-butadiene rubber, ethylene-propylene rubber, butyl rubber, cis-polybutadiene, cis-polyisoprene, polyurethane, polyamide and combinations thereof.

This application is a continuation-in-part of U.S. patent application Ser. No. 10/799,865, filed March 11, 2004, which is a continuation-in-part of U.S. patent application Ser. No. 10/663,324 filed Sept. 15, 2003

### BACKGROUND OF THE INVENTION

The present invention relates generally to polymeric compositions useful in the manufacture of elastomeric components. More particularly, the present invention relates to the field of hoses for use in the automotive industry.

Hoses, particularly rubber hoses are used in a variety of applications in the automotive industry as fuel feed hoses, torque converter hoses, power steering hoses and air conditioner hoses, as well as for industrial and household utility applications such as hydraulic hoses, refrigeration hoses, washing machine hoses, propane gas feed hoses, high pressure air hoses, garden hoses, etc.

It is generally known that rubber surfaces do not always exhibit desired resistance against chemical loads such as organic gases and solvents. Therefore, other approaches for improving the organic gas and solvent resistance of rubber materials included using rubber materials which have a different polarity than the organic gas or solvent, increasing the crosslinking of the rubber material, adding or increasing certain additives, and increasing the wall thickness of the rubber tube material. All of these approaches have a down side. For example, the use of a rubber material having a polarity different from the organic gas or solvent requires the use of expensive rubber materials such as chloroprene rubber, acrylic rubber, epichlorohydrin rubber, and the like; increasing the degree of crosslinking of the rubber used detracts from the softness and flexibility of the rubber; the addition of additives affects the processability and certain physical properties of the rubber; and increasing the wall thickness of the rubber material also increases the weight of the structure. Generally, these undesirable effects overshadow any advantage gained in the improved gas and solvent resistance.

Other approaches employed to improve the impermeability of multilayered rubber hoses include the use of a metal film as a barrier layer coated on one of the inner layers. Such disclosures appear, for example, in U.S. Pat. No. 318,458 to Fletcher where there is disclosed a multilane tubular structure made from India rubber and having a tin foil liner. Other prior art patents such as U.S. Pat. Nos. 4559,793 to Hanes et al.; 4,759,455 to Campbell et al.; 5,182,147 to Davis; 5,271,977 to Yoshikawa et al; 5,360,037 to Lindstrom; 5,398,729 to Spurgat; and 5,476,121 to Yoshikawa et al. have attempted similar methods to reduce the permeability of fluids and/or gases through various tubes. Commonly assigned U.S. Pat. No. 6,074,717 to Little et al.; and U.S. Pat. Nos. 4,779,673 and 5,488,975 to Chiles et al. disclose metal coated synthetic rubber hoses used for circulation of fluids in radiant heating systems in houses and in businesses and disclose the use of an inner nylon tubular layer having a metal layer surrounding the nylon layer.

Polymeric material used to form the hose for accommodating fluids and gases under elevated pressures and/or high temperatures such as in automotive air conditioner cooler hoses and power steering hoses must meet other critical requirements. For example, the polymeric material must exhibit low permeability to FREON or other coolant gases to prevent such gases from escaping from the hose. Also such polymeric hose must be able to prevent outside moisture from entering the interior of the hose where it could contaminate the fluid or gas. In addition, the polymeric hose must be capable of withstanding high heat and pressure, be able to withstand engine and impact vibration, and be capable of forming gas-tight connections.

In the case of composite hoses for accommodating coolant fluid for automotive air conditioners, etc., polymeric materials such as polychloroprene (CR), acrylonitrile-butadiene rubber (NBR), chlorosulfonated polyethylene (CSM), chlorinated polyethylene (CPE), polyacrylate (PA), ethylene-acrylic rubber (AEM), alkyl acrylate copolymer (ACM), polyvinyl acetate, acrylonitrile-butadiene rubber (NBR), hydrogenated acrylonitrile-butadiene rubber (HNBR), ethylene-propylene-diene terpolymer (EPDM), cis-polybutadiene, cis-polyisoprene, polyurethane, polyamides such as nylon are often used as the material for forming the hose. For example, nylon 6 and nylon 66 are very low in coolant gas permeability, but are relatively high in moisture permeability. On the other hand, nylon 11 and 12 are relatively low in moisture permeability and less susceptible to hydrolysis, but are moderately high in gas permeability. Blends of any of the various nylons with other nylons, olefins or other materials are also used in such applications. For example, blends such as nylon 6, nylon 4, nylon 66, nylon 11, nylon 12, have been made to take advantage of desirable characteristics of one or more of such nylons and, at the same time, reduce the effects of any undesirable characteristics.

Ethylene-vinyl acetate copolymer (EVM) compositions are well known. For example, U.S. Pat. Nos. 6,492,454; 5,942,580; 5,837,791; 5,830,941; 5,807,948; 5,744,566; 5,698,651; 5,362,533; 5,135,988; 4,338,227 and 4,309,332 describes various ethylene-vinyl acetate copolymers and the uses thereof. Copolymers of ethylene and vinyl acetate exhibit elastomeric characteristics and are commonly used to improve adhesion properties of hot melt, solvent-based and pressure-sensitive adhesives. It is generally well known that the use of ethylene-vinyl acetate copolymers in the automotive industry and commercial applications are mostly limited to coatings, adhesives, gaskets, O-rings and the like. For example, “Ultrathene”, a series of ethylene-vinyl acetate copolymers manufactured by Quantum Chemical, is typically used for adhesives, conversion coatings and thermoplastic modifiers. Such EVA copolymers exhibit a wide range of melt indexes. Ethylene-vinyl acetate copolymers are also marketed by Bayer under the trade name “Levapren”. These EVA copolymers are described as oil and heat resistant materials, which may be used in air hose applications. U.S. Pat. No. 6,605,327 to Ramey et al. teaches the use of two separate layers of an ethylene-vinyl copolymer in the manufacture of a multilayer hose. However, there is no mention of a copolymer containing a first vinyl ester and a second vinyl ester in which the first and second vinyl ester are different from each other.

Polymeric materials, such as ethylene-vinyl acetate copolymers and blends thereof have been employed in the wire and cable industry as a sheath or cover material surrounding electrical wires. For example, polymeric blends of ethylene-vinyl acetate copolymers with ethylene-vinyl acetate-carbon monoxide terpolymers, which are particularly useful in applications where flame retardant, low smoke, oil resistant, flexible systems are desirable as a wire coating. For example, blends of ethylene-vinyl acetate copolymers with ethylene-vinyl acetate-carbon monoxide terpolymers are described in U.S. Pat. No. 6,133,367 to Arhart for use in automotive wire and cable coating applications. Other patents disclosing the use of ethylene-vinyl acetate copolymers as wire and cable coatings include U.S. Pat. No. 4,349,605 to Biggs et al.; U. S. Pat. No. 4,381,326 to Biggs et al; U.S. Pat. No. 4,477,523 to Biggs et al.; U.S. Pat. No. 5,191,004 to Maringer et al.; U.S. Pat. No. 5,225,460 to Maringer et al.; and U.S. Pat. No. 5,226,489 to Maringer et al. None of the references describe a self supporting tubular structure, nor is there any teaching of a copolymer containing a first vinyl ester and a second vinyl ester wherein the two vinyl esters are different.

Choosing the right material or combination of materials to be used in the construction of automotive hoses is becoming more and more difficult because the hoses are now required to withstand higher pressures and temperatures than previous hoses performing the same tasks. Also mandated regulations require that the hoses exhibit greater impermeability rates and resist stress over longer periods of time while maintaining manufacturing costs at an acceptable level. Therefore, the manufacturer of automotive hoses finds it necessary to come up with newer and better materials and combinations of materials to meet these rising needs.

### SUMMARY OF THE INVENTION

It has now been discovered that certain copolymers containing two or more vinyl esters in which the two or more vinyl esters are different from each other, exhibit high temperature and pressure resistance, improved hydrocarbon fluid resistance and high damping characteristics. Such copolymers have been found to have promise as a material for use in the manufacture of a variety of industrial rubber goods such as a tubular structures, e.g., automotive hoses ; belts, such as transmission belts; seal members; dampers; engine mounts, particularly oil filled engine mounts; air duct housing; gaskets; CV joint boots, and the like. In particular, copolymers of a first vinyl ester and a second different vinyl ester are found to be especially effective in forming hoses useful in the transmission of various automotive fluids and gases, e.g., engine oil cooler fluids, transmission oil cooler fluids, power steering fluids, air conditioner fluids, radiator fluids, and heater fluids. For example, copolymers containing a first vinyl ester of a C₂ to C₆ carboxylic acid, e.g., vinyl acetate, and a second vinyl ester which is different from the first vinyl ester such as vinyl palmitate, vinyl stearate, vinyl laurate, etc. exhibit high temperature resistance, hydrocarbon fluid resistance and high damping characteristics. Typically, the second vinyl ester is a higher vinyl ester having a higher number of carbons, e.g., C₁₀ or higher. Such vinyl esters have promise as a material for use in the manufacture of elastomeric automotive components such as hoses, belts, seals, dampers, engine mounts, etc. In particular, the vinyl ester copolymers are useful in the manufacture of hoses for transporting various automotive fluids and gases, e.g., engine oil cooler fluids, transmission oil cooler fluids, power steering fluids, radiator fluids, heater fluids, and the like. Preferably, the copolymer is a vinyl acetate-vinyl laurate copolymer.

In one embodiment of the invention, the polymeric component of the polymeric composition is a vinyl ester copolymer containing a first vinyl ester and a second vinyl ester wherein the first vinyl ester is a vinyl ester of a lower carboxylic acid or acyl halide having about six or less carbons and the second vinyl ester is a higher vinyl ester containing about ten or more carbons. Typically, the polymeric composition is a copolymer wherein the first vinyl ester is a C₂ - C₆ aliphatic carboxylic acid and the second vinyl ester is a higher vinyl ester containing at least 10 carbons. Preferably, the first vinyl ester is vinyl acetate and the second vinyl ester is vinyl laurate.

In another embodiment of the invention, the vinyl ester copolymer containing the first vinyl ester and the second vinyl ester is blended with another polymeric component such as ethylene-vinyl esters of a lower carboxylic acid, e.g., ethylene-vinyl acetate copolymers, chlorinated polyolefins, chlorosulfonated polyolefins, polychloroprene (CR), ethylene-acrylic rubber (AEM), alkyl acrylate copolymer (ACM), polyvinyl acetate, ethylene-propylene-diene monomer (EPDM), styrene-butadiene rubber (SBR), acrylonitrile-butadiene rubber (NBR), hydrogenated acrylonitrile-butadiene rubber (HNBR), ethylene-propylene rubber (EPR), ethylene-propylene-hexadiene terpolymer, butyl rubber, cis-polybutadiene, cis-polyisoprene, polyurethane, polyamide, and the like, and mixtures thereof.

Other ingredients or additives which serve to provide or enhance the required heat tolerance, pressure resistance, fluid permeation resistance, etc., may be included as additional components of the polymeric composition of the present invention. Such ingredients or additives include: process aids, fillers, plasticizers, metal oxides and/or hydroxides, peroxides, coagents, antioxidants, and other ingredients which are customarily added to polymeric materials to provide a desired purpose.

In one aspect of the invention, there is provided a heat tolerant, pressure resistant elastomeric component composition containing a copolymer of a first vinyl ester and a second vinyl ester which is different from the first vinyl ester, wherein the composition exhibits improved hydrocarbon fluid impermeability when compared to ethylene-vinyl acetate copolymers. The composition is useful in the manufacture of various automotive components such as hoses, belts, seals, dampers, engine mounts, etc.

In another aspect of the invention, there is provided a heat tolerant, pressure resistant elastomeric automotive component, such as an elastomeric hose, which comprises a first vinyl ester of a C₂ to C₆ carboxylic acid or acyl halide copolymerized with a second vinyl ester which is different from the first vinyl ester such as a fatty ester. The hose is particularly useful in the automotive industry to transport fluids and gases at high temperatures and pressures. For example, the hose of the invention is particularly useful in the transportation of air conditioner fluids, power steering fluids, transmission oil cooler fluids, etc. where the first vinyl ester-second vinyl ester copolymer material forming the hose exhibits the required heat tolerance, pressure resistance, impermeability resistance to the fluid being transported through the hose etc.

In still another aspect of the invention, there is provided a method for producing an elastomeric hose in accordance with the present invention which comprises forming the hose from a first vinyl ester of a lower carboxylic acid or acyl halide copolymerized with a second vinyl ester which is a different vinyl ester.

The term “fluid” as used herein to define the substance transported through the tubular structure is intended to include gases as well as liquids.

### DETAILED DESCRIPTION OF THE INVENTION

In accordance with a first embodiment of the invention, a polymeric composition comprising a copolymer of a first vinyl ester of a C₂ - C₆ lower aliphatic carboxylic with a second vinyl ester which is a different vinyl ester is described. Typically, the first vinyl ester is vinyl acetate, and the second vinyl ester is vinyl laurate.

Vinyl ester copolymers containing vinyl acetate and vinyl laurate are commercially available under the trade names Vinnapas B500/20 VL and Vinnapas 500/40 VL from Wacker-Chemie GMbH. In accordance with the invention, the vinyl ester copolymers containing a first vinyl ester and a second vinyl ester are compounded with a plurality of additives such as certain process aids, fillers, plasticizers, metal oxides and/or hydroxides, peroxides, coagents, antioxidants, etc. to enhance the heat tolerance, pressure resistance and/or hydrocarbon fluid impermeability of the vinyl ester compositions of the present invention.

While the vinyl acetate-vinyl laurate copolymer is typically the sole polymeric component and the primary ingredient of the composition, the vinyl acetate-vinyl laurate copolymers of the invention may also be combined with up to about 75% by weight of other elastomeric polymers to provide certain desirable properties to the vinyl acetate-vinyl laurate copolymers. Typically, such other elastomeric polymers include ethylene-vinyl ester copolymers in which the vinyl ester component is an ester of a C₂ to C₆ carboxylic acid. Preferably, the ethylene-vinyl ester copolymer is an ethylene-vinyl acetate copolymer. Ethylene-vinyl acetate copolymers are commercially available from a number of manufacturers including DuPont, Millennium Petrochemicals, Nova-Borealis Compounds LLC, AT Plastics Inc., Exxon, ATO Chem., Bayer AG, and others. Suitable ethylene-vinyl acetate copolymers have a vinyl acetate content greater than about 40%, preferably greater than about 50% and most preferably about 60 to 90% vinyl acetate. Ethylene-vinyl acetate copolymers available from Bayer AG under the name Levapren have been found to be particularly useful in the present invention. Other such elastomeric polymers include chlorinated polyolefins, chlorosulfonated polyolefins, polychloroprene (CR), ethylene-acrylic rubber (AEM), alkyl acrylate copolymer (ACM), polyvinyl acetate, ethylene-propylene-diene monomer (EPDM), styrene-butadiene rubber (SBR), acrylonitrile-butadiene rubber (NBR), hydrogenated acrylonitrile-butadiene rubber (HNBR), ethylene-propylene rubber (EPR), ethylene-propylene-hexadiene terpolymer, butyl rubber, cis-polybutadiene, cis-polyisoprene, polyurethane, polyamide, and the like, and mixtures thereof. may also be employed as long as they do not adversely affect the desirable properties of the hose. Such elastomeric polymers are well known and are readily available in the rubber industry.

Additional materials may also be employed as additives compounded into the copolymer composition in appropriate amounts for the purpose of providing desired characteristics of the composition. These additional materials include, for example, process aids fillers; plasticizers; metal oxides or hydroxides; peroxides; coagents; and antioxidants. Other additives such as vulcanization accelerators commonly used in polymeric compositions for use in preparing hoses may be added in amounts to provide their desired effect.

Suitable processing aids include stearic acid, stearates, polyethylene, amines, oils, organic esters, organic phosphate esters and the like.

Suitable fillers include materials, such as carbon black, silicon dioxide, fumed silica, precipitated silica, diatomaceous earth, magnesium carbonate, magnesium silicate, aluminum silicate titanium dioxide, talc, mica, aluminum sulfate, calcium sulfate, graphite, wollastonite, molybdenum disulfide, clay, calcium carbonate and combinations thereof.

Suitable plasticizers include materials such as hydrocarbons, glycols, aldehydes, ethers, esters, ether-esters, and the like, and combinations thereof.

Suitable metal oxides and metal hydroxides include zinc oxide, zinc hydroxide, magnesium oxide, magnesium hydroxide, calcium oxide, calcium hydroxide, aluminum hydroxide, and the like, and combinations thereof.

Suitable peroxides include 2,5-dimethyl-2,5-di(t-butylperoxy)hexyne-3; 2,5-dimethyl-2,5-di(t-butylperoxy)hexane; α,α′-bis-(t-butylperoxy)-p-diisopropylbenzene, dicumyl peroxide, di-t-butyl peroxide; 1,1 -bis(t-butylperoxy)-3,3,3-trimethylcyclohexane; 2,4-dichlorobenzoyl peroxide; benzoyl peroxide; p-chlorobenzoyl peroxide; 4,4-bis(t-butylperoxy) valerate; t-butylcumyl peroxide; di-t-amyl peroxide; t-butyl hydroperoxide, and the like, and combinations thereof.

Suitable coagents include N, N′,m-Phenylenedimaleimide (HVA2) and other bismaleimides; triallyl cyanurate; triallyl isocyanurate; diallyl terephthalate; 1,2-vinyl polybutadienes; di- and tri-finctional methacrylates and diacrylates; and metal ion versions of these coagents, and the like, and combinations thereof.

Suitable antioxidants include phenols, hydrocinnamates, diphenylamines, hydroquinone, hydroquinolines, mercaptobenzimidazoles, and the like, and combinations thereof.

In accordance with a first embodiment of the present invention, an automotive component is formed from:

about 10 to 75% by weight vinyl acetate-vinyl laurate copolymer;

about 0 to 75% by weight ethylene-vinyl acetate; and

25 to 75% by weight additives selected from the group consisting of process aids fillers; plasticizers; metal oxides or hydroxides; peroxides; coagents; and antioxidants.

In accordance with a preferred aspect of the invention, the automotive component is formed from:

about 10 to 50% by weight vinyl acetate-vinyl laurate copolymer;

about 0 to 75% by weight ethylene-vinyl acetate; and

up to about 8% by weight process aid selected from the group consisting of stearic acid, stearates, polyethylene, amines, oils, organic esters, organic phosphate esters and combinations thereof;

up to about 60% by weight filler selected from the group consisting of carbon black, silicon dioxide, fumed silica, precipitated silica, diatomaceous earth, magnesium carbonate, magnesium silicate, aluminum silicate titanium dioxide, talc, mica, aluminum sulfate, calcium sulfate, graphite, wollastonite, molybdenum disulfide, clay, calcium carbonate and combinations thereof;

up to about 15% by weight plasticizer selected from the group consisting of hydrocarbons, glycols, aldehydes, ethers, esters, ether-esters and combinations thereof;

up to about 10% by weight metal oxides and/or hydroxides selected from the group consisting of zinc oxide, zinc hydroxide, magnesium oxide, magnesium hydroxide, calcium oxide, calcium hydroxide, aluminum hydroxide and combinations thereof;

up to about 2% by weight peroxide selected from the group consisting of 2,5-dimethyl-2,5-di(t-butylperoxy)hexyne-3; 2,5-dimethyl-2,5-di(t-butylperoxy)hexane; dicumyl peroxide; α,α′-bis-(t-butylperoxy)-p-diisopropylbenzene; di-t-butyl peroxide; 1,1 -bis(t-butylperoxy)-3,3,3 -trimethylcyclohexane; 2,4-dichlorobenzoyl peroxide; benzoyl peroxide; p-chlorobenzoyl peroxide; 4,4-bis(t-butylperoxy) valerate; and combinations thereof;

up to about 5% by wight coagent selected from the group consisting of maleimides, triallyl cyanurate, triallyl isocyanurate, diallyl terephthalate, 1,2-vinyl polybutadiene, di- and tri-functional methacrylates, diacrylates, metal ion versions thereof and combinations thereof; and

up to about 3% weight antioxidant selected from the group consisting of phenols, hydrocinnamates, hydroquinones, hydroquinolines, diphenylamines, mercaptobenzimidazoles, and combinations thereof. Unless otherwise specified, the weight percent express for each of the copolymer containing the first vinyl ester and the second vinyl ester, the elastomeric ethylene-vinyl ester, the other elastomeric polymers, and the additives, are based upon the total weight of the polymeric composition forming the automotive component.

In accordance with a more preferred aspect of the present invention, the automotive component comprises:

about 10 to 50% by weight vinyl acetate-vinyl laurate copolymer containing about 50 to 80% vinyl acetate and about 50 to 20% vinyl laurate;

about 0 to 50% by weight ethylene-vinyl acetate copolymer containing about 50 to 80% vinyl acetate and about 80 to 50% ethylene;

about 0.2 to 0.7% by weight stearic acid;

about 23 to 38% by weight carbon black;

about 2 to 5% by weight silicon dioxide;

about 3 to 7% by weight trioctyl trimellitate;

about 0.1 to 7% by weight adipate type plasticizer;

about 0.1 to 8% by weight magnesium oxide;

about 0.1 to 0.75% by weight 1 -octanedecanamine;

about 0.1 to 0.75% by weight organic phosphate ester;

about 0.5 to 4% by weight organic peroxide;

about 0.25 to 1% by weight triallyl cyanurate;

about 0.25 to 1% by weight N,N′, n-phenylenedimaleimide;

and mixtures thereof.

In another aspect of the invention, a tubular structure formed from the aforementioned vinyl acetate-vinyl laurate compositions is described. The tubular structure is useful for conveying automotive fluids in, for example, engine oil cooler, transmission oil cooler, power transmission cooler, radiator, heater, etc. A reinforcing material is generally employed in the manufacture of the hose to provide strength to the hose structure. The reinforcement materials include natural fibers such as cotton; synthetic fibers such as polyester, nylon, rayon, aramid; and metal wire. The reinforcement may be applied by knit or maypole type braid methods. Typically, the reinforcement material is applied to the annular extrudate in a two-layer spiral format in which one layer is applied in a clockwise direction and the other layer is applied in a counter-clockwise direction.

An outer protective cover layer may be employed over the reinforcing layer in a mono-extrusion of an annular configuration to provide protection for the hose from the outer environment. The cover is a protective layer of any of the commercially recognized materials for such use, e.g., elastomers, thermoplastic polymers, thermosetting polymers and the like. Typically, the protective cover is a synthetic elastomeric having good heat resistance, oil resistance, weather resistance and flame resistance. Preferably, the outer protective cover layer is a synthetic elastomer selected from the group consisting of styrene-butadiene rubber; butadiene-nitrile rubber such as butadiene-acrylonitrile rubber; chlorinated rubber; chlorosulfonated polyethylene; chlorinated polyethylene; vinylethylene-acrylic rubber; acrylic rubber; epichlorohydrin rubber such as Hydrion 200, a copolymer of epichlorohydrin and ethylene oxide available from DuPont ECO; polychloroprene rubber; polyvinyl chloride; ethylene-propylene copolymers; ethylene-propylene-diene terpolymer; ultra high molecular weight polyethylene; high density polyethylene; and blends thereof.

In a second embodiment of the invention, a method for manufacturing heat tolerant, pressure resistant hoses having improved hydrocarbon fluid resistance is provided. The method includes providing a copolymer of a first vinyl ester and a second vinyl ester; mixing the first vinyl ester-second vinyl ester copolymer with various additives and, optionally with other elastomeric polymers via open mill mixing or internal mixer such as a Banbury mixer; and forming a heat tolerant, pressure resistant hose having improved hydrocarbon fluid impermeability.

In a preferred method for manufacturing the tubular structure of the invention, a continuous spiral production method is employed which comprises:

providing an inner layer of a material produced in a mono-extrusion of an annular configuration;

applying a reinforcement material to the annular extrudate in a two-layer spiral format in which one layer is applied in a clockwise direction and the other layer is applied in a counter-clockwise direction. applying an outer layer over the reinforcement layer in a mono-extrusion of an annular configuration;

vulcanizing the composite tubular structure in an autoclave. The method For manufacturing the hoses of the present invention comprises:

Providing about 10 to 50% by weight of a first elastomeric copolymer of a first vinyl ester and a second vinyl ester, wherein said first vinyl ester is a vinyl ester of a lower carboxylic acid and said second vinyl ester is a vinyl ester of a fatty acid;

providing up to about 50% by weight of a second elastomeric polymer based upon the weight of said composition, wherein said elastomeric polymer is selected from the group consisting of ethylene-vinyl ester of a C₂ to C₆ carboxylic acid, chlorinated polyolefins, chlorosulfonated polyolefins, polychloroprene, ethylene-acrylic rubber, alkyl acrylate copolymer, polyvinyl acetate, acrylonitrile-butadiene rubber, hydrogenated acrylonitrile-butadiene rubber, ethylene-propylene diene terpolymer, styrene-butadiene rubber, ethylene-propylene rubber, butyl rubber, cis-polybutadiene, cis-polyisoprene, polyurethane, polyamide and combinations thereof.

providing about 25 to 75% by weight of a plurality of additives selected from the group consisting of process aids, fillers, plasticizers, metal oxides, metal hydroxides, peroxides, coagents, antioxidants and combinations thereof;

forming a blend from the first elastomeric copolymer, the second elastomeric polymer, and the plurality of additives

forming a tubular structure of said blend, said tubular structure having an outer surface and an inner surface through which automotive fluids are transported;

applying a reinforcing layer to the outer surface of the tubular structure wherein the reinforcing layer formed from cotton fibers; synthetic fibers selected from the group consisting of polyester, nylon, rayon and aramid; or metal wire; and

applying a cover layer to an outer surface of the reinforcing layer wherein the cover layer is formed from a synthetic elastomeric selected from the group consisting of styrene-butadiene rubber; butadiene-nitrile rubber; chlorinated rubber; chlorosulfonated polybutadiene; vinylethylene-acrylic rubber; chlorinated rubber; acrylic rubber; epichlorohydrin rubber, polychloroprene rubber; polyvinyl chloride; ethylene-propylene copolymers; ethylene-propylene-diene terpolymers; ultra high molecular weight polyethylene; high density polyethylene; and blends thereof; and

vulcanizing the hose.

### EXAMPLES

| | Parts per hundred of polymer (phr) | | | | | | |
|---|---|---|---|---|---|---|---|
| | 1 | 2 | 3 | 4 | 5 | 6 | 7 |
| Levapren ® 600 HV | 100 | 75 | 75 | | | | |
| Vinnapas ® B 500/20 VL | | 25 | | | 50 | 50 | |
| Vinnapas ® B 500/40 VL | | | 25 | 100 | 50 | 50 | 100 |
| Stearic Acid | 1 | 1 | 1 | 1 | 1 | 1 | 1 |
| Magnesium Oxide | 10 | 10 | 10 | 10 | 10 | 10 | 10 |
| N650 Carbon Black | 70 | 70 | 70 | 70 | 70 | 70 | 70 |
| Silicon Dioxide | 5 | 5 | 5 | 5 | 5 | 5 | 5 |
| Trioctyl Trimellitate | 7.5 | 7.5 | 7.5 | 7.5 | 7.5 | 7.5 | 7.5 |
| Adipate Plasticizer | 2.5 | 2.5 | 2.5 | 2.5 | 2.5 | 2.5 | 2.5 |
| 1-Octadecanamine | 1 | 1 | 1 | 1 | 1 | 1 | 1 |
| Poly(oxy-1,2-ethanediyl),alpha-octadecyl- | 1 | 1 | 1 | 1 | 1 | 1 | 1 |
| omega-hydroxy,-phosphate | | | | | | | |
| Triallyl Cyanurate, 72% Dispersion | 1 | 1 | 1 | 1 | 1 | 1 | 1 |
| N,N′-m-Phenylene Dimaleimide | 1 | 1 | 1 | 1 | 3 | 1 | 1 |
| Dicumyl Peroxide; 99% | 2.4 | 2.4 | 2.4 | 2.4 | 2.4 | 2.4 | 2.4 |
| 95% a,a′,bis t,butylperoxy diisopropylbenzene | | | | | | 1 | 1 |
| 4,4′-Di(methylbenzyl)diphenylamine | 2 | 2 | 2 | 2 | 2 | 2 | 2 |

Cured 20 minutes @ 175° C.
Original Properties

| | | | | | | | |
|---|---|---|---|---|---|---|---|
| Tensile Strength; psi | 1990 | 1598 | 1661 | 1001 | 1054 | 1263 | 1186 |
| Elongation % | 262 | 240 | 265 | 184 | 164 | 139 | 134 |
| 100% Modulus; psi | 841 | 748 | 615 | 121 | 837 | 1033 | 947 |
| Hardness; Shore A | 74 | 79 | 76 | 78 | 82 | 85 | 78 |
| Compression Set, 70 h. @ 175° C. | 49 | 52 | 52 | 61 | 65 | 59 | 59 |

After 168 hours @ 175° C. in Air

| | | | | | | | |
|---|---|---|---|---|---|---|---|
| Tensile Strength; psi | 1796 | 1617 | 1356 | 1152 | 1668 | 1692 | 1293 |
| Elongation % | 262 | 182 | 194 | 103 | 51 | 47 | 66 |
| 100% Modulus; psi | 1129 | 1429 | 1199 | 1075 | n/a | n/a | n/a |
| Hardness; Shore A | 84 | 92 | 90 | 83 | 96 | 82 | 87 |

After 70 hours @ 175° C. in Chrysler MS9602 Automatic Transmission Fluid

| | | | | | | | |
|---|---|---|---|---|---|---|---|
| Tensile Strength; psi | 1624 | 1559 | 1341 | 1063 | 998 | 1118 | 947 |
| Elongation % | 265 | 240 | 272 | 119 | 122 | 122 | 149 |
| 100% Modulus; psi | 518 | 581 | 406 | 900 | 973 | 1055 | 628 |
| Hardness; Shore A | 56 | 74 | 54 | 81 | 89 | 88 | 66 |
| Volume Change; % | 28 | 21 | 26 | 19 | 9 | 9 | 17 |

After 70 hours @ 175° C. in IRM 903 Oil

| | | | | | | | |
|---|---|---|---|---|---|---|---|
| Tensile Strength; psi | 1225 | 1156 | 954 | 392 | 834 | 851 | 557 |
| Elongation % | 202 | 205 | 186 | 123 | 138 | 107 | 107 |
| 100% Modulus; psi | 490 | 484 | 409 | 306 | 614 | 534 | 489 |
| Hardness; Shore A | 39 | 55 | 35 | 37 | 80 | 75 | 48 |
| Volume Change; % | 79 | 63 | 76 | 59 | 32 | 31 | 52 |

Levapren is an ethylene-vinyl acetate copolymer available form Bayer Corporation
Vinnapas is a vinyl acetate-vinyl laurate copolymer available from Wacker-Chemie GMbH

The percentages of the various ingredients forming the automotive components of the present invention are defined as weight percentages based upon the total weight of the elastomeric composition from which the automotive component is derived.

The ratios of ethylene and vinyl ester in the ethylene-vinyl ester copolymers in the, and the percentages of the vinyl esters of a lower carboxylic acid and the fatty acid esters of the present invention are defined as mol percent.

While preferred embodiments of the invention have been described in detail and exemplified in the above examples and specification, it will be apparent to those skilled in the art that the invention may be modified without deviating from the scope of the invention. Therefore, the foregoing examples and description are to be considered exemplary rather than limiting and are not to be limited thereto.

What is claimed is:

1. A vulcanized, heat tolerant, pressure resistant elastomeric automotive component: exhibiting improved hydrocarbon fluid impermeability compared to conventional automotive components, said automotive component comprising:
about 10 to 75% by weight of a matrix material comprising a copolymer of a first vinyl ester and a second vinyl ester, wherein said first vinyl ester is a vinyl ester of a lower carboxylic acid and said second vinyl ester is a vinyl ester of a fatty acid;
0 to about 50% by weight of an elastomeric polymer based upon the weight of said composition, wherein said elastomeric polymer is selected from the group consisting of an ethylene-vinyl ester of a C₂ to C₆ carboxylic acid, chlorinated polyolefins, chlorosulfonated polyolefins, polychloroprene, ethylene-acrylic rubber, alkyl acrylate copolymer, polyvinyl acetate, acrylonitrile-butadiene rubber, hydrogenated acrylonitrile-butadiene rubber, ethylene-propylene diene terpolymer, styrene-butadiene rubber, ethylene-propylene rubber, butyl rubber, cis-polybutadiene, cis-polyisoprene, polyurethane, polyamide and combinations thereof; a
about 25 to 75% by weight of one or more additives selected from the group consisting of process aids, fillers, plasticizers, metal oxides, metal hydroxides, peroxides, coagents, antioxidants and combinations thereof.

2. The automotive component of claim 1, wherein said first vinyl ester is vinyl acetate and said second vinyl ester is vinyl laurate.

3. The automotive component of claim 2 wherein said vinyl acetate-vinyl laurate copolymer comprises about 50 to 80% vinyl acetate and about 50 to 20% vinyl laurate.

4. The automotive component of claim 5 wherein said vinyl acetate-vinyl laurate copolymer comprises about 40 to 80% vinyl acetate and about 60 to 20% ethylene.

5. The automotive component of claim 2 comprising:
about 10 to 75% by weight vinyl acetate-vinyl laurate copolymer;
about 0 to 50% by weight ethylene-vinyl acetate;
up to about 8% by weight one or more processing aids selected from the group consisting of stearic acid, stearates, polyethylene, amines, oils and organic esters;
up to about 60% by weight one or more fillers selected from the group consisting of carbon black, graphite, silicone dioxide, fumed silica, precipitated silica, diatomaceous earth, magnesium carbonate, calcium carbonate, magnesium silicate, aluminum silicate titanium dioxide, talc, mica, aluminum sulfate, calcium sulfate, wollastonite, molybdenum disulfide, clay, calcium carbonate and combinations thereof;
up to about 15% by weight of one or more plasticizers selected from the group consisting of hydrocarbons, glycols, aldehydes, ethers, esters, ether-esters and combinations thereof;
up to about 8% by weight of one or more metal oxides and/or hydroxides selected from the group consisting of zinc oxide, zinc hydroxide, magnesium oxide, magnesium hydroxide, calcium oxide, calcium hydroxide, aluminum hydroxide and combinations thereof;
up to about 5% by weight of one or more peroxides selected from the group consisting of 2,5-dimethyl-2,5-di(t-butylperoxy)hexyne-3; 2,5-dimethyl-2,5-di(t-butylperoxy)hexane; dicumyl peroxide; α,α′-bis-(t-butylperoxy)-p-diisopropylbenzene; di-t-butyl peroxide; 1,1 -bis(t-butylperoxy)-3,3,5-trimethylcyclohexane; 2,4-dichlorobenzoyl peroxide; benzoyl peroxide; p-chlorobenzoyl peroxide; 4,4-bis(t-butylperoxy) valerate; t-butylcumyl peroxide; di-t-amyl peroxide; t-butyl hydroperoxide and combinations thereof;
up to about 5% by weight of one or more coagents selected from the group consisting of maleimides, triallyl cyanurate, triallyl isocyanurate, diallyl terephthalate, 1,2-vinyl polybutadiene, di- and tri-functional methacrylates, diacrylates, metal ion versions thereof and combinations thereof; and
up to about 3% by weight of one or more antioxidants selected from the group consisting of phenols, hydrocinnamates, hydroquinones, hydroquinolines, diphenylamines, mercaptobenzimidazoles and combinations thereof.

6. The automotive component of claim 5, wherein said composition comprises:
about 10 to 50% by weight vinyl acetate-vinyl laurate copolymer containing about 50 to 80% vinyl acetate and about 50 to 20% vinyl laurate;
about 0 to 50% by weight ethylene-vinyl acetate copolymer containing about 50 to 80% vinyl acetate and about 20 to 50% ethylene;
about 0.2 to 0.7% by weight stearic acid;
about 23 to 38% by weight carbon black;
about 2 to 5% by weight silicone dioxide;
about 3 to 7% by weight trioctyl trimellitate;
about 0.1 to 7% by weight adipate type plasticizer;
about 0.1 to 8% by weight magnesium oxide;
about 0.1 to 0.75% by weight 1-octanedecanamine;
about 0.1 to 0.75% by weight organic phosphate ester;
about 0.5 to 4% by weight organic peroxide;
about 0.25 to 1% by weight triallyl cyanurate;
about 0.25 to 1% by weight N,N′, m-phenylenedimaleimide; and
about 0.25 to 2% by weight antioxidant selected from the group consisting of phenols, hydrocinnamates, diphenylamines, hydroquinones, hydroquinolines and mixtures thereof.

7. The automotive component of claim 1 wherein said elastomeric automotive component is a tubular structure, belt, seal member, damper, engine mount, air duct housing, gasket, or CV joint boot.

8. The component of claim 7, wherein said automotive component is a tubular structure exhibiting improved hydrocarbon fluid impermeability, said tubular structure further comprising:
a reinforcing layer on an outer surface of said tubular structure, said reinforcing layer formed from cotton fibers; synthetic fibers selected from the group consisting of polyester, nylon, rayon and aramid; or metal wire; and
a cover layer applied to an outer surface of said reinforcing layer, said cover layer formed from a synthetic elastomeric selected from the group consisting of styrene-butadiene rubber; butadiene-nitrile rubber; chlorinated rubber; chlorosulfonated polybutadiene; vinylethylene-acrylic rubber; chlorinated rubber; acrylic rubber; epichlorohydrin rubber, polychloroprene rubber; polyvinyl chloride; ethylene-propylene copolymers; ethylene-propylene-diene terpolymers; ultra high molecular weight polyethylene; high density polyethylene; and blends thereof.

9. The component of claim 8 wherein said tubular structure is a hose for transporting engine oil cooler fluids, transmission oil cooler fluids, power steering fluids, air conditioner fluids, radiator fluids, and heater fluids.

10. A vulcanized, heat tolerant, pressure and hydrocarbon resistant hose exhibiting improved hydrocarbon fluid impermeability compared to conventional hoses, said hose comprising:
About 10 to 50% by weight of a copolymer of a first vinyl ester and a second vinyl ester, wherein said first vinyl ester is a vinyl ester of a lower carboxylic acid and said second vinyl ester is a vinyl ester of a fatty acid;
About 25 to 75% by weight of one or more additives selected from the group consisting of process aids, fillers, plasticizers, metal oxides, metal hydroxides, peroxides, coagents, antioxidants and combinations thereof; and
Up to about 50% by weight of an elastomeric polymer based upon the weight of said composition, wherein said elastomeric polymer is selected from the group consisting of ethylene-vinyl ester of a C₂ to C₆ carboxylic acid, chlorinated polyolefins, chlorosulfonated polyolefins, polychloroprene, ethylene-acrylic rubber, alkyl acrylate copolymer, polyvinyl acetate, acrylonitrile-butadiene rubber, hydrogenated acrylonitrile-butadiene rubber, ethylene-propylene diene terpolymer, styrene-butadiene rubber, ethylene-propylene rubber, butyl rubber, cis-polybutadiene, cis-polyisoprene, polyurethane, polyamide and combinations thereof.
a reinforcing layer on an outer surface of said tubular structure, said reinforcing layer formed from cotton fibers; synthetic fibers selected from the group consisting of polyester, nylon, rayon and aramid; or metal wire; and
a cover layer applied to an outer surface of said reinforcing layer, said cover layer formed from a synthetic elastomeric selected from the group consisting of styrene-butadiene rubber; butadiene-nitrile rubber; chlorinated rubber; chlorosulfonated polybutadiene; vinylethylene-acrylic rubber; chlorinated rubber; acrylic rubber; epichlorohydrin rubber, polychloroprene rubber; polyvinyl chloride; ethylene-propylene copolymers; ethylene-propylene-diene terpolymers; ultra high molecular weight polyethylene; high density polyethylene; and blends thereof.

11. The hose of claim 10, wherein said hose comprises:
about 10 to 75% by weight vinyl acetate-vinyl laurate copolymer containing about 50 to 80% vinyl acetate and about 50 to 20% vinyl laurate;
about 0 to 50% by weight ethylene-vinyl acetate copolymer containing about 50 to 80% vinyl acetate and about 20 to 50% ethylene;
about 0.2 to 0.7% by weight stearic acid;
about 23 to 38% by weight carbon black;
about 2 to 5% by weight silicone dioxide;
about 3 to 7% by weight trioctyl trimellitate;
about 0.1 to 7% by weight adipate type plasticizer;
about 0.1 to 8% by weight magnesium oxide;
about 0.1 to 0.75% by weight 1-octanedecanamine;
about 0.1 to 0.75% by weight organic phosphate ester;
about 0.5 to 4% by weight organic peroxide;
about 0.25 to 1% by weight triallyl cyanurate;
about 0.25 to 1% by weight N,N′, m-phenylenedimaleimide; and
about 0.25 to 2% by weight antioxidant selected from the group consisting of phenols, hydrocinnamates, diphenylamines, hydroquinones, hydroquinolines and mixtures thereof.
a reinforcing layer on an outer surface of said tubular structure, said reinforcing layer formed from cotton fibers; synthetic fibers selected from the group consisting of polyester, nylon, rayon and aramid; or metal wire; and
a cover layer applied to an outer surface of said reinforcing layer, said cover layer formed from a synthetic elastomeric selected from the group consisting of styrene-butadiene rubber; butadiene-nitrile rubber; chlorinated rubber; chlorosulfonated polybutadiene; vinylethylene-acrylic rubber; chlorinated rubber; acrylic rubber; epichlorohydrin rubber, polychloroprene rubber; polyvinyl chloride; ethylene-propylene copolymers; ethylene-propylene-diene terpolymers; ultra high molecular weight polyethylene; high density polyethylene; and blends thereof.

12. A method for preparing a vulcanized, heat tolerant, pressure and hydrocarbon resistant hose having improved hydrocarbon fluid impermeability compared to conventional hoses, said method comprising:
providing a first elastomeric copolymer of a first vinyl ester and a second vinyl ester, wherein said first vinyl ester is a vinyl ester of a lower carboxylic acid and said second vinyl ester is a vinyl ester of a fatty acid;
providing a second elstomeric polymer selected from the group consisting of ethylene-vinyl ester of a C₂ to C₆ carboxylic acid, chlorinated polyolefins, chlorosulfonated polyolefins, polychloroprene, ethylene-acrylic rubber, alkyl acrylate copolymer, polyvinyl acetate, acrylonitrile-butadiene rubber, hydrogenated acrylonitrile-butadiene rubber, ethylene-propylene diene terpolymer, styrene-butadiene rubber, ethylene-propylene rubber, butyl rubber, cis-polybutadiene, cis-polyisoprene, polyurethane, polyamide and combinations thereof;
providing a plurality of additives selected from the group consisting of ethylene-vinyl ester of a C₂ to C₆ carboxylic acid, chlorinated polyolefins, chlorosulfonated polyolefins, polychloroprene, ethylene-acrylic rubber, alkyl acrylate copolymer, polyvinyl acetate, acrylonitrile-butadiene rubber, hydrogenated acrylonitrile-butadiene rubber, ethylene-propylene diene terpolymer, styrene-butadiene rubber, ethylene-propylene rubber, butyl rubber, cis-polybutadiene, cis-polyisoprene, polyurethane, polyamide and combinations thereof;
forming a blend of said first elastomeric copolymer, said second elastomeric polymer and said plurality of additives, said blend comprising about 10 to 50% by weight of said first elastomeric copolymer, about 0 to 50% by weight of said second elastomeric polymer, and about 25 to 75% by weight of said plurality of additives selected from the group consisting of process aids, fillers, plasticizers, metal oxides, metal hydroxides, peroxides, coagents, antioxidants and combinations thereof;
forming a tubular structure from said blend, said tubular structure having an inner surface through which automotive fluids are transported and an outer surface;
applying a reinforcing layer on said outer surface of said tubular structure, wherein said reinforcing layer comprising cotton fibers; synthetic fibers selected from the group consisting of polyester, nylon, rayon and aramid; or metal wire; and
applying a cover layer on an outer surface of said reinforcing layer, wherein said cover layer comprises a synthetic elastomeric selected from the group consisting of styrene-butadiene rubber; butadiene-nitrile rubber; chlorinated rubber; chlorosulfonated polybutadiene; vinylethylene-acrylic rubber; chlorinated rubber; acrylic rubber; epichlorohydrin rubber, polychloroprene rubber; polyvinyl chloride; ethylene-propylene copolymers; ethylene-propylene-diene terpolymers; ultra high molecular weight polyethylene; high density polyethylene; and blends thereof.

13. The method of claim 11, wherein said first vinyl ester is vinyl acetate and said second vinyl ester is vinyl laurate.

14. The method of claim 12, wherein said vinyl acetate-vinyl laurate copolymer comprises about 50 to 80% vinyl acetate and about 50 to 20% by weight vinyl laurate.

15. The method of claim 12, wherein said elastomeric polymer is an ethylene-vinyl acetate copolymer comprising about 40 to 80% vinyl acetate and about 60 to 20% ethylene.

16. The method of claim 11, wherein said blend comprises:
about 10 to 50% by weight of an elastomeric vinyl acetate-vinyl laurate copolymer containing about 50 to 80% of a vinyl acetate and about 50 to 20% vinyl laurate;
0 to about 50% by weight of said ethylene-vinyl acetate copolymer; and
about 25 to 75% by weight of a plurality of additives comprising:
about 0.8 to 2% by weight one or more processing aids selected from the group consisting of stearic acid, stearates, polyethylene, amines, oils, organic esters, organic phosphate esters and combinations thereof;
about 20 to 60% filler selected from the group consisting of carbon black, silicon dioxide, fumed silica, precipitated silica, diatomaceous earth, magnesium carbonate, magnesium silicate, aluminum silicate titanium dioxide, talc, mica, aluminum sulfate, calcium sulfate, graphite, wollastonite, molybdenum disulfide, clay, calcium carbonate, and combinations thereof;
about 3 to 15% plasticizer selected from the group consisting of hydrocarbons, glycols, aldehydes, ethers, esters, ether-esters, and combinations thereof;
about 0 to 10% metal oxides and/or hydroxides selected from the group consisting of zinc oxide, zinc hydroxide, magnesium oxide, magnesium hydroxide, calcium oxide, calcium hydroxide, aluminum hydroxide, and combinations thereof;
about 0.5 to 2% peroxide selected from the group consisting of 2,5-dimethyl-2,5-di(t-butylperoxy)hexyne-3; 2,5-dimethyl-2,5-di(t-butylperoxy)hexane; dicumyl peroxide; α,α′-bis-(t-butylperoxy)-p-diisopropylbenzene; di-t-butyl peroxide; 1,1 -bis(t-butylperoxy)-3,3,5-trimethylcyclohexane; 2,4-dichlorobenzoyl peroxide; benzoyl peroxide; p-chlorobenzoyl peroxide; t-butylcumyl peroxide; di-t-amyl peroxide; t-butyl hydroperoxide, and combinations thereof;
about 0 to 5% coagent selected from the group consisting of maleimides, triallyl cyanurate, triallyl isocyanurate, diallyl terephthalate, 1,2-vinyl polybutadiene, di- and tri-functional methacrylates, diacrylates, and combinations thereof; and
about 0 to 0.3% antioxidant selected from the group consisting of phenols, hydrocinnamates, hydroquinones, hydroquinolines, diphenylamines, mercaptobenzimidazoles and, combinations thereof.

17. The method of claim 10, wherein said hose comprises:
about 10 to 75% by weight vinyl acetate-vinyl laurate copolymer containing about 50 to 80% vinyl acetate and about 50 to 20% vinyl laurate;
about 0 to 50% by weight ethylene-vinyl acetate copolymer containing about 50 to 80% vinyl acetate and about 20 to 50% ethylene;
about 0.2 to 0.7% by weight stearic acid;
about 23 to 38% by weight carbon black;
about 2 to 5% by weight silicone dioxide;
about 3 to 7% by weight trioctyl trimellitate;
about 0.1 to 7% by weight adipate type plasticizer;
about 0.1 to 8% by weight magnesium oxide;
about 0.1 to 0.75% by weight 1 -octanedecanamine;
about 0.1 to 0.75% by weight organic phosphate ester;
about 0.5 to 4% by weight organic peroxide;
about 0.25 to 1% by weight triallyl cyanurate;
about 0.25 to 1% by weight N,N′, m-phenylenedimaleimide; and
about 0.25 to 2% by weight antioxidant selected from the group consisting of phenols, hydrocinnamates, diphenylamines, hydroquinones, hydroquinolines and mixtures thereof;
a reinforcing layer on an outer surface of said tubular structure, said reinforcing layer formed from cotton fibers; synthetic fibers selected from the group consisting of polyester, nylon, rayon and aramid; or metal wire; and
a cover layer applied to an outer surface of said reinforcing layer, said cover layer formed from a synthetic elastomeric selected from the group consisting of styrene-butadiene rubber; butadiene-nitrile rubber; chlorinated rubber; chlorosulfonated polybutadiene; vinylethylene-acrylic rubber; chlorinated rubber; acrylic rubber; epichlorohydrin rubber, polychloroprene rubber; polyvinyl chloride; ethylene-propylene copolymers; ethylene-propylene-diene terpolymers; ultra high molecular weight polyethylene; high density polyethylene; and blends thereof.

18. In a vulcanized tubular structure for conveying fluids automotive engine cooler, transmission oil cooler, power transmission cooler, radiator or heater, the improvement which comprises employing as said tubular structure, an elastomeric tubular structure through which fluids are conveyed, said structure exhibiting improved hydrocarbon fluid impermeability compared to conventional tubular structures, said elastomeric tubular structure comprising:
about 10 to 50% by weight of a vinyl acetate-vinyl laurate copolymer containing about 50 to 80% vinyl acetate and about 50 to 20% vinyl laurate;
about 0 to about 75% by weight of an ethylene-vinyl acetate copolymer containing about 40 to 80% vinyl acetate and about 60 to 20% ethylene;
about 0.8 to 2% by weight one or more processing aids selected from the group consisting of stearic acid, stearates, polyethylene, amines, oils, organic esters, organic phosphate esters and combinations thereof;
about 20 to 60% filler selected from the group consisting of carbon black, silicon dioxide, fumed silica, precipitated silica, diatomaceous earth, magnesium carbonate, magnesium silicate, aluminum silicate titanium dioxide, talc, mica, aluminum sulfate, calcium sulfate, graphite, wollastonite, molybdenum disulfide, clay, calcium carbonate and combinations thereof;
about 3 to 15% plasticizer selected from the group consisting of hydrocarbons, glycols, aldehydes, ethers, esters, ether-esters and combinations thereof;
about 0 to 10% metal oxides and/or hydroxides selected from the group consisting of zinc oxide, zinc hydroxide, magnesium oxide, magnesium hydroxide, calcium oxide, calcium hydroxide, aluminum hydroxide and combinations thereof;
about 0.5 to 2% peroxide selected from the group consisting of 2,5-dimethyl-2,5-di(t-butylperoxy)hexyne-3; 2,5-dimethyl-2,5-di(t-butylperoxy)hexane; dicumyl peroxide; α,α′-bis-(t-butylperoxy)-p-diisopropylbenzene; di-t-butyl peroxide; 1,1-bis(t-butylperoxy)-3,3,5-trimethylcyclohexane; 2,4-dichlorobenzoyl peroxide; benzoyl peroxide; p-chlorobenzoyl peroxide; t-butylcumyl peroxide; di-t-amyl peroxide; t-butyl hydroperoxide and combinations thereof;
about 0 to 5% coagent selected from the group consisting of maleimides, triallyl cyanurate, triallyl isocyanurate, diallyl terephthalate, 1,2-vinyl polybutadiene, di- and tri-functional methacrylates, diacrylates, and combinations thereof; and
about 0 to 0.3% antioxidant selected from the group consisting of phenols, hydrocinnamates, hydroquinones, hydroquinolines, diphenylamines, mercaptobenzimidazoles and combinations thereof;
said elastomeric tubular structure further including a reinforcing layer over said tubular structure, said reinforcing layer comprising natural or synthetic fibers selected from the group consisting of cotton, polyester, nylon, rayon and aramid; or metal wire, and a cover layer over said reinforcing layer, said cover layer comprising a synthetic elastomeric selected from the group consisting of styrene-butadiene rubber, butadiene-acrylonitrile rubber, chloroprene rubber, chlorinated polyethylene, chlorosulfonated polyethylene, epichlorohydrin-ethylene oxide copolymer, polyvinyl chloride, and blends thereof.

19. The structure of claim 18 wherein said elastomeric tubular structure comprises:
about 10 to 50% by weight of a vinyl acetate-vinyl laurate copolymer containing about 50 to 80% vinyl acetate and about 50 to 20% vinyl laurate;
about 0 to about 75% by weight of an ethylene-vinyl acetate copolymer containing about 40 to 80% vinyl acetate and about 60 to 20% ethylene;
about 0.2 to 0.7% by weight stearic acid;
about 23 to 38% by weight carbon black;
about 2 to 5% by weight silicone dioxide;
about 3 to 7% by weight trioctyl trimellitate;
about 0.1 to 7% by weight adipate type plasticizer;
about 0.1 to 8% by weight magnesium oxide;
about 0.1 to 0.75% by weight 1-octanedecanamine;
about 0.1 to 0.75% by weight organic phosphate ester;
about 0.5 to 4% by weight organic peroxide;
about 0.25 to 1% by weight triallyl cyanurate;
about 0.25 to 1% by weight N,N′, m-phenylenedimaleimide; and
about 0.25 to 2% by weight antioxidant selected from the group consisting of phenols, hydrocinnamates, diphenylamines, hydroquinones, hydroquinolines and mixtures thereof;
a reinforcing layer on an outer surface of said tubular structure, said reinforcing layer formed from cotton fibers; synthetic fibers selected from the group consisting of polyester, nylon, rayon and aramid; or metal wire; and
a cover layer applied to an outer surface of said reinforcing layer, said cover layer formed from a synthetic elastomeric selected from the group consisting of styrene-butadiene rubber; butadiene-nitrile rubber; chlorinated rubber; chlorosulfonated polybutadiene; vinylethylene-acrylic rubber; chlorinated rubber; acrylic rubber; epichlorohydrin rubber, polychloroprene rubber; polyvinyl chloride; ethylene-propylene copolymers; ethylene-propylene-diene terpolymers; ultra high molecular weight polyethylene; high density polyethylene; and blends thereof.
